(19) United States
(12) Patent Application Publication
(10) Pub. No.: US 2026/0110988 A1
(43) Pub. Date: Apr. 23, 2026

(54) METHOD FOR MAKING A BARREL ARBOR

(71) Applicant: Nivarox-FAR S.A., Le Locle (CH)

(72) Inventors: Dorian MOREL, Bonnétage (FR); Frédéric HAFELI, Tramelan (CH)

(73) Assignee: Nivarox-FAR S.A., Le Locle (CH)

(21) Appl. No.: 19/354,190

(22) Filed: Oct. 9, 2025

(30) Foreign Application Priority Data
Oct. 22, 2024 (EP) 24208207.1

(51) Int. Cl. G04D 3/00; B23D 37/22; G04B 1/16

(52) U.S. Cl. CPC G04D 3/0005; B23D 37/22; G04B 1/16

(57) ABSTRACT

A method for manufacturing a barrel arbor (1) used in horology, arranged to pivot around a pivot axis (D). The method including the following steps: taking a bar; profile-turning the bar to form at least one cylindrical portion (13) including a vertical surface and a horizontal surface; machining the cylindrical portion (13) to form the core that includes a hook (2), a support surface (3) and a countersink (4); and simultaneously using a broaching tool by making several translational to-and-fro movements in the direction of the pivot axis (D) of the arbor.

### CROSS REFERENCE TO RELATED APPLICATIONS

This application is claiming priority based on European Patent Application No. 24208207.1 filed on Oct. 22, 2024.

### TECHNICAL FIELD OF THE INVENTION

The invention relates to a method for manufacturing a barrel arbor used in horology, pivoting around a pivot axis and comprising a hook for hooking onto an inner coil of a barrel spring in a single winding direction, and comprising, on a first part of its periphery near the hook and downstream of the hook in the winding direction, a curved spring support surface for supporting the inner coil.

### TECHNOLOGICAL BACKGROUND

In a mechanical horology movement, the barrel is the motor organ that provides the necessary energy to move the various components. The barrel comprises a drum, a cover closing the drum, a barrel arbor around which the drum and cover freely pivot, and a barrel spring embedded in the drum. The outer coil of the mainspring is held by the drum wall. The barrel arbor comprises a part known as the core, which carries a hook to which the inner coil of the barrel spring is attached. The barrel arbor is rotationally secured to a ratchet and, via this ratchet, can be rotated by a winding stem (manual winding) or an oscillating mass (automatic winding) on the movement to wind the mainspring and thereby store energy.

The arbor on a horology barrel is a small component that undergoes considerable stress, requiring it to be made with particular care. Its geometry makes it generally quite costly to machine, particularly due to the presence of the hook, which requires machining around its entire perimeter, on one hand to ensure that it hooks onto the spring securely, and on the other hand to ensure that the eyelet in this spring can be fitted with sufficient slack.

Barrel arbors are usually machined in several milling operations. However, some angles are hard to produce with the milling cutters commonly used, as the cutter radii are too large.

One purpose of the present invention is therefore to provide a simpler method for manufacturing a barrel arbor that requires fewer steps.

### SUMMARY OF THE INVENTION

To this end, the present invention relates to a method for manufacturing a barrel arbor used in horology, arranged to pivot around a pivot axis, comprising a core comprising a support surface for an inner coil of a spring, from which support surface a hook projects to engage in an eyelet in the inner coil, the core also comprising, upstream of the hook in the winding direction of the spring, a countersink for holding the end of the spring.

According to the invention, the method comprises the following steps:
taking a bar;
profile-turning the bar to form at least one cylindrical portion comprising a vertical surface and a horizontal surface;
machining the cylindrical portion to form the core that comprises the hook, the support surface, and the countersink, simultaneously using a broaching tool by making several translational to-and-fro movements in the direction of the pivot axis of the arbor.

According to other advantageous variants of the invention:
the to-and-fro movements are carried out in 0.2 mm passes;
the support surface of the spring comprises a sector with a helical cross-section and a sector with a cylindrical cross-section;
the countersink has a curved surface;
the arbor material is chosen among metals or metal alloys;
the vertical surface for forming the hook and the curved support surface are machined simultaneously by the same broaching tool;
the broaching tool is a forming tool with a blank form identical to the desired form of the barrel arbor.

The invention also relates to a barrel arbor obtained using the method in accordance with the invention.

### BRIEF DESCRIPTION OF THE DRAWINGS

Other characteristics and advantages of the invention will become apparent from the detailed description below, with reference to the accompanying drawings, in which:

FIG. 1 is a perspective view of a barrel arbor according to the invention;

FIG. 2 is a cross-sectional view along plane P of the arbor in FIG. 1;

FIGS. 3 to 5 show the steps in the method for manufacturing the barrel arbor;

FIGS. 6a and 6b show a schematic view of the cutting tool used to machine the barrel arbor;

FIG. 7 shows a schematic view of the machining tool positioned on the barrel arbor to be machined.

### DETAILED DESCRIPTION OF THE INVENTION

The invention relates to the manufacture of a barrel arbor 1 used in horology, comprising a hook 2 for hooking onto an inner coil of a barrel spring in a single winding direction S.

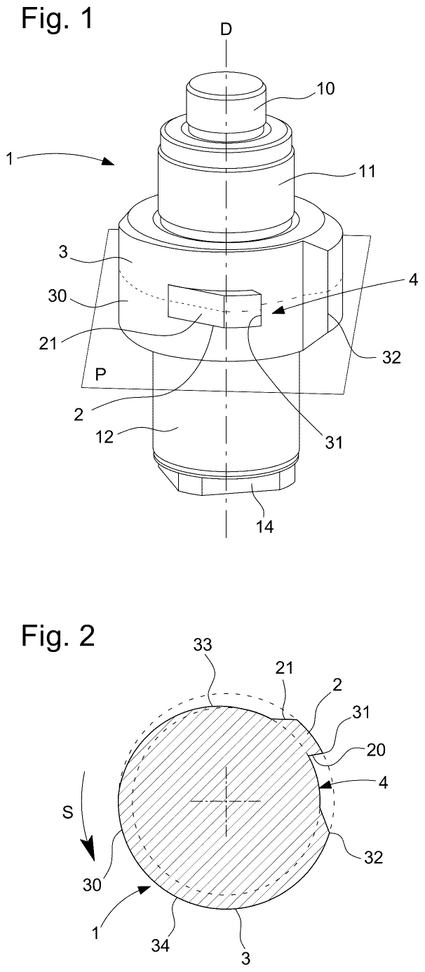

Referring to FIGS. 1 and 2, a barrel arbor 1 according to the invention comprises at least one pivot 10 for pivoting it in a bearing in a horology movement around an axis D, a portion with a square cross-section 14 on which a ratchet can be fitted, two cylindrical portions 11, 12 for pivoting, respectively, a barrel drum and a barrel cover, and a core 3. The core 3 carries a hook 2 for fastening the inner coil of a spiral barrel spring (not shown in the figures) embedded in the drum. The winding direction of the spring is shown in FIG. 2 by the arrow S.

More specifically, the core 3 comprises a support surface 30 for the barrel spring, on which the hook 2 is located. This support surface 30 extends, in the winding direction S of the barrel spring, from a first edge 31 to a second edge 32. The core 3 also comprises, upstream of the hook 2, a countersink 4 for receiving the inner end of the barrel spring, and which joins the first and second edges 31, 32.

The hook 2 is designed to be engaged in an eyelet or window in the inner coil of the barrel spring to enable it to be surrounded on its entire perimeter by the wall of the eyelet. The hook 2 comprises two opposite end surfaces 20, 21. In the winding direction S, end surface 20 is upstream of end surface 21 and level with the first edge 31. This end surface 20 acts as a support for the wall of the eyelet when the spring is wound. As can be seen in the figures, the flat end surface 20 is inclined, in the direction of its extension from the pivot axis D, towards the upstream end in the winding direction S for improved hold on the hook 2 by the barrel spring.

With regard to the countersink 4, it has a surface with a curved profile. However, the surface of the countersink could have another form, such as a flat surface.

In the example illustrated in the figures, the support surface 30 is comprised of a first part 33 extending from the first edge 31 and with a radius that increases in the winding direction S, and of a second part 34 extending from the first part 33 to the second edge 32 and with a constant radius.

The support surface 30 therefore comprises at least one sector with a helical cross-section, where the spring support surface 3 comprises, from the hook 2 and in the winding direction S, a sector with a helical cross-section 33, then a sector with a cylindrical cross-section 34. To accompany the development of the inner coil of the barrel spring, the spring support surface 3 accordingly has an increasing radius in the winding direction S.

It will be understood that producing the countersink 4, the hook 2 and the spring support surface 30 with a single tool is advantageous in terms of both cost and time.

FIG. 5 illustrates the simultaneous machining of the countersink 4, the hook 2 and the support surface 30 with the same broaching tool translating along an axis A coaxial with the axis D.

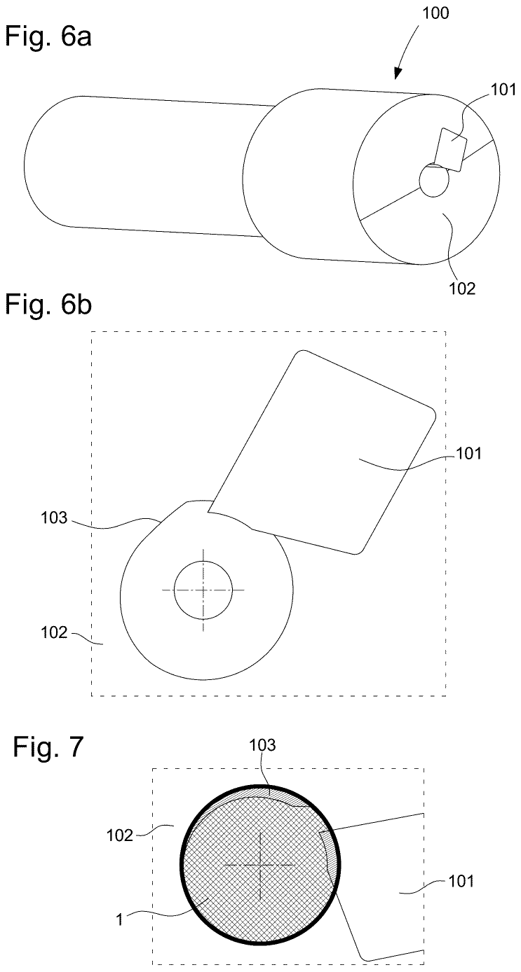

As can be seen in FIGS. 6a and 6b, the broaching tool 100 is a forming tool with a blank form identical to the desired form of the barrel arbor.

The tool 100 thus has two parts 101, 102 assembled so as to obtain a “radius-free” geometry at the intersection of the two parts of the tool. The first part 101 of the tool is in the form of a tooth arranged to machine the countersink 4 and the flat end surface 20 of the hook 2.

The second part 102 of the tool comprises an opening 103 with a profile that has a first sector corresponding to the hook and a second sector with a first portion having a helical cross-section and a second portion having a cylindrical cross-section forming the support surface 30 of the spring.

The method for manufacturing a barrel arbor 1 according to the invention comprises a first step which consists of taking a metal or metal alloy bar.

The next step, illustrated in FIG. 3, consists of profile-turning the bar to form at least a first diameter comprising a vertical surface and a horizontal surface to form at least a first pivot 10 for pivoting in a bearing. Other revolving surfaces, such as cylindrical portions 11, 12 for pivoting a cover or drum, can also be formed in this step.

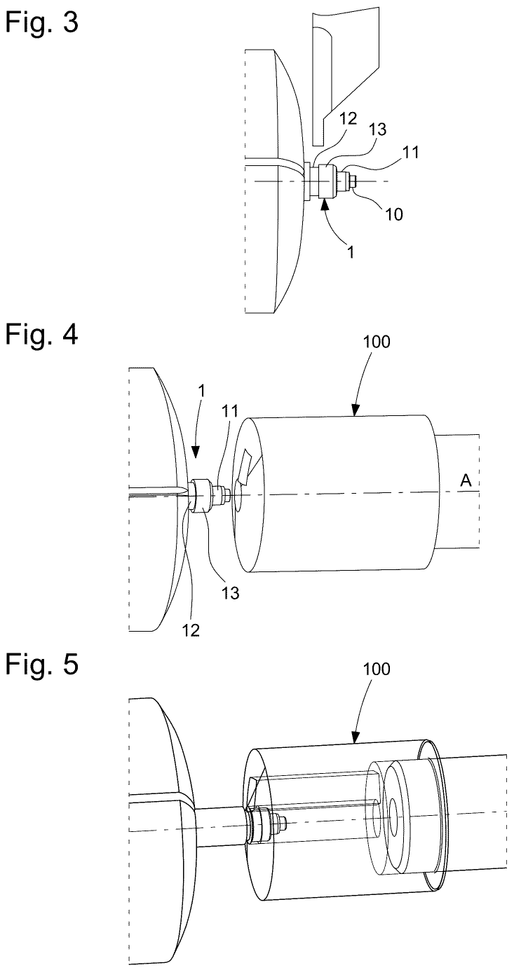

Then, as can be seen in FIG. 4, the broaching tool is positioned facing the barrel arbor, so that the tool and arbor are coaxial.

Lastly, as illustrated in FIG. 5, the hook 2, the support surface 30 and the countersink 4 are blanked out using the broaching tool 100, which has a blank form identical to the desired form of the core 3 of the barrel arbor, by making several translational to-and-fro movements along the axis A of the tool, which is coaxial with the pivot axis D of the arbor 1.

Preferably, the to-and-fro movements used to machine the arbor 1 are carried out in 0.2 mm passes.

Once the first side of the arbor 1 has been machined, it is turned over to machine the other side of the arbor identically.

The invention also relates to a barrel arbor obtained according to the method according to the invention.

1. A method for manufacturing a barrel arbor (1) used in horology, arranged to pivot around a pivot axis (D) and comprising a core (3) comprising a support surface (30) for an inner coil of a spring, from which support surface (30) a hook (2) projects to engage in an eyelet in said inner coil, the core (3) also comprising upstream of the hook (2) in the winding direction(S) of the spring, a countersink (4) for holding the end of the spring, the method comprising the following steps:
taking a bar;
profile-turning the bar to form at least one cylindrical portion (13) comprising a vertical surface and a horizontal surface;
machining the cylindrical portion (13) to form the core that comprises the hook (2), the support surface (30) and the countersink (4), simultaneously using a broaching tool by making several translational to-and-fro movements in the direction of the pivot axis (D) of the arbor.

2. The method for manufacturing a barrel arbor (1) used in horology according to claim 1, wherein the to-and-fro movements are carried out in 0.2 mm passes.

3. The method for manufacturing a barrel arbor (1) used in horology according to claim 1, wherein the support surface of the spring (30) comprises a sector with a helical cross-section (33) and a sector with a cylindrical cross-section (34).

4. The method for manufacturing a barrel arbor (1) used in horology according to claim 1, wherein the countersink (4) has a curved surface.

5. The method for manufacturing a barrel arbor (1) used in horology according to claim 1, wherein the arbor material is chosen among metals or metal alloys.

6. The method for manufacturing a barrel arbor (1) used in horology according to claim 1, wherein the vertical surface (20) for forming the hook (2) and the curved support surface (6) are machined simultaneously by the same broaching tool.

7. The method for manufacturing a barrel arbor (1) used in horology according to claim 1, wherein the broaching tool is a forming tool with a blank form identical to the desired form of the barrel arbor.

8. A barrel arbor obtained by the method according to claim 1.
